(19) United States
(12) Patent Application Publication
(10) Pub. No.: US 2019/0319905 A1
(43) Pub. Date: Oct. 17, 2019

(54) MAIL PROTECTION SYSTEM

(71) Applicant: Inky Technology Corporation, Rockville, MD (US)

(72) Inventors: David M. Baggett, Potomac, MD (US); Andrew B. Goldberg, Columbia, MD (US)

(21) Appl. No.: 15/952,375

(22) Filed: Apr. 13, 2018

(51) Int. Cl. H04L 12/58

(52) U.S. Cl. CPC H04L 51/12

(57) ABSTRACT

A system for characterizing email communications. Mail is first processed by a Sending Entity Identifier (SEI), to determine which person, company, or type of sender the mail appears to be from, answering the question “What entity would a typical human conclude this email is from”? The output of the SEI will typically be a person (“John Doe”) or a brand (“Amazon”). The SEI passes that information, along with the email itself, to a Sending Entity Verifier (SEV), to verify whether the email really is from the entity the SEI says it's from. A Markup Engine may add a human-readable banner and/or machine-readable headers and then pass the email to a Disposition Engine which may deliver, quarantine, or folder the email (e.g., to a Junk Folder) accordingly.

### TECHNICAL FIELD

This patent application relates generally to electronic mail systems and methods and more particularly to detecting emails that are brand forgeries or impersonations.

### BACKGROUND

Historically speaking, email protection systems have attempted to classify a given email message into one of two categories: good or bad. This binary classification likely originates in early work on spam filtering: an email is either “spam” (bad) or “ham” (good), and the goal of the filtering software is to determine the category to assign to the email message.

The typical machine learning framework used to classify email into binary categories is Bayesian Learning. Early spam detection systems examined the words in each email against statistical priors established through Bayesian training—in other words, by building up models of word frequencies in human-labeled spam and ham emails and then comparing each incoming email against these models.

Over time, practitioners have extended the Bayesian approach to look at email properties other than words: header values, URLs, domain names, etc. Other learning frameworks have also been employed, such as Support Vector Machines, Decision Trees, Neural Networks, and more, but the general problem setting has remained the same: given the content of the email, classify as spam or ham.

Some have proposed the use of brand-specific indicators to authenticate email messages. Recently, a Brand Indicators for Message Identification (BIMI) process has been proposed that would permit domain owners to coordinate with entities called Mail User Agents (MUAs) to display brand-specific Indicators next to properly authenticated messages. See for example: https://authindicators.github.io/rfc-brand-indicators-for-message-identification/

### SUMMARY

Unfortunately, attempts to apply these techniques to so-called phishing emails—emails that impersonate an individual or brand—have largely failed. One reason for this is the problem of “replay attacks”: an attacker can take a real email from a major brand or from an individual and simply resend this email with minor modifications from a similar-looking domain. There is thus very little evidence in the mail itself that the mail is not genuine, and therefore few features that could be employed by a Bayesian classifier.

The approaches described herein instead take a different approach to determining whether an email represents a phishing attack. For example, the techniques can detect when an email is attempting to impersonate a trusted brand or a trusted person. It not only detects whether a message originates from an untrusted source, but in one example for the case of brand forgery, matches any graphical images in the message against a library of famous brand name images or logos. In the case of a trusted person forgery, social graphs may be utilized.

Instead of viewing mail protection as a single-pass binary classification, each mail is processed in two discrete steps. The first step attempts to answer the question, with an automated process in software, “What entity does this email appear to be from?” Given the output of the first step, the second step (again an automated process) attempts to answer the question “Is the email in fact from the entity it appears to be from”?

More particularly, an example automated method for determining if an email is a forgery may first proceed to identifying who an apparent sender of the email would be perceived to be by a human. A first step in this part is determining if the apparent sender is associated with a brand by tokenizing any hyperlink or domain name found in the email, and then matching tokens against a list of brand names. When an image is found in the email, the image (or a segment thereof) may be matched against a set of brand name images. Prominent text found in the email, may also be matched against a list of brand names. The apparent sender may be determined to be an individual by maintaining a social graph using address fields in the email and matching those against a graph of previously received emails.

A second part of the process is for determining an actual sender of the email. When the apparent sender is a brand, the process tries to compare one or more attributes of a digital signature of the email using a sender domain authentication protocol. When when the apparent sender is an individual, the process then uses one or more heuristics including one or more of trust on first use, matching the apparent sender against sender profiles and/or sender-recipient profiles.

Finally, the process determines the email is a forgery if the apparent sender does not match the actual sender.

Other details are apparent from the description of preferred embodiments that follows.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating the preferred embodiments.

FIG. 1 is a high-level diagram of a system that may implement mail protection systems according to the teachings herein.

FIG. 2 is a flow diagram for a sending entity identifier in a first category.

FIG. 3 is a flow diagram for a sending entity identifier in a second category.

FIG. 4 is a flow for a sending entity verifier flow diagram in the first category.

FIG. 5 is a flow for the sending entity verifier in the second category.

FIG. 6 is a flow diagram of a markup engine.

FIG. 7 is a high-level social graph.

FIGS. 8A and 8B are an example of a deep-sea phishing mail attempt to impersonate the American Express® brand.

FIG. 8C illustrate how the system might catch this impersonation of American Express.

FIG. 9 is another example of brand impersonation for Amazon®.

FIG. 10 is a sample email that has been flagged as impersonating an individual.

FIG. 11 is an example of email with a domain name that is confusable with a famous domain name.

FIG. 12 is an example email flagged because it has a URL with an IP address.

FIG. 13 is an example of flagging misleading hyperlinks in an email.

FIG. 14 is a is an example of identifying emails with password requests.

FIG. 15 is an example of flagging URLs that have been reported as suspicious.

FIG. 16 is an example email flagged as a request for a wire transfer.

FIG. 17A is detailed flow for how a user might report a suspicious mail as a brand impersonation.

FIG. 17B is an example reporting page.

FIGS. 18A and 18B are a flow diagram for a process that permits user reporting but retains the confidentiality of email content.

### DETAILED DESCRIPTION OF AN EXAMPLE EMBODIMENT

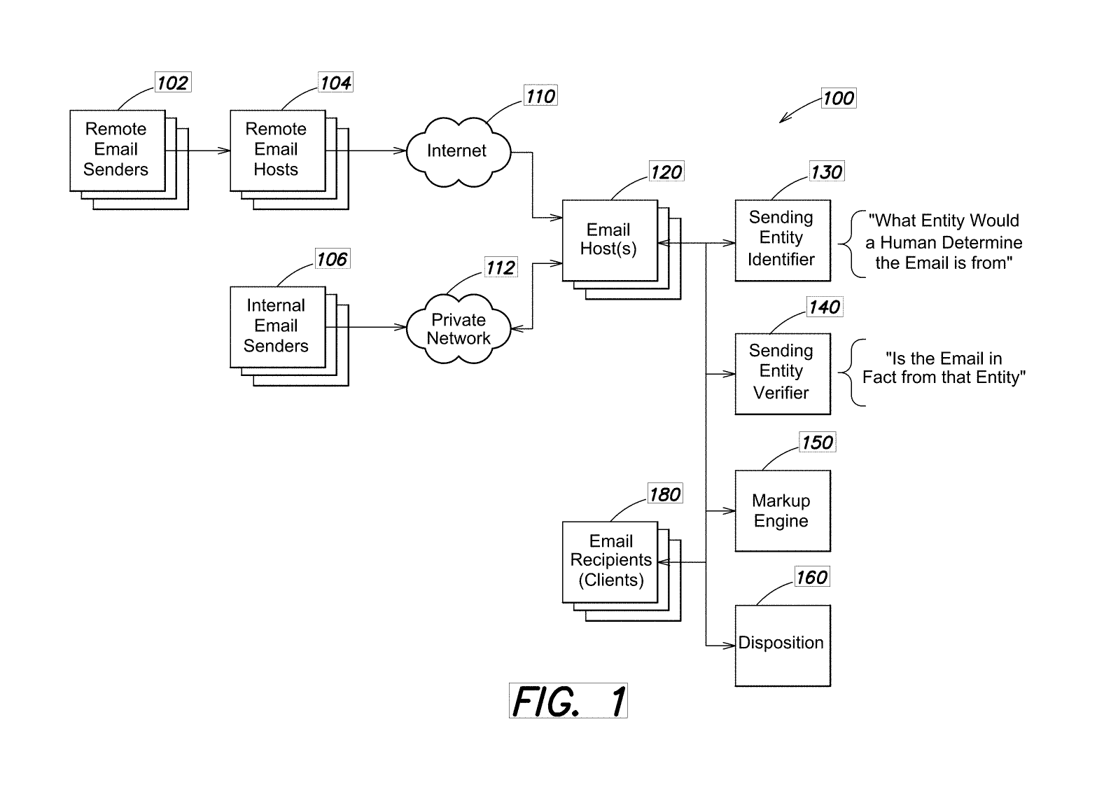

An email protection system that uses the techniques described herein may be implemented in a number of different ways. A high level block diagram of a data processing environment that may provide an email protection service is shown in FIG. 1. The environment 100 includes one or more remote email senders 102, one or more remote email hosts 104, and internet connection(s) 110. Internal email senders 106 within an organization may use private (or local) network(s) 112. Emails arrive at one or more email hosts (MX) 120 from the remote and internal senders in this way or in other ways.

The email protection service uses a Sending Identity Identifier (SEI) 130 and Sending Entity Verifier (SEV) 140 to process emails from email host 120, as well as markup engine 150 and disposition engine 160, eventually forwarding processed emails to one or more email recipients (clients) 180.

SEI 130, SEV 140, markup engine 150 and/or disposition engine 160 may be implemented as program code executing within an email host 120 in one embodiment. However they may also be partially or wholly integrated within email recipients 180, or may be one or more separate processes, or standalone physical, virtual, or cloud processors as a remote data processing service.

In the environment shown in FIG. 1, email arrives from either a public-facing MX host 120 which is connected to the Internet 110 (“external mail”) or from a Private Network 112 (“internal mail”). In either case, mail is processed by the Sending Entity Identifier (SEI) 130, which uses a variety of techniques to determine which person, company, or other kind of sender the mail appears to be from. Specifically, the job of the SEI 130 is to programmatically answer the question “What entity would a typical human say this email is from” as accurately as possible. The output of the SEI will typically be a person (“John Doe”) or a brand (“Amazon”).

Once the SEI 130 has determined what entity the email appears to be from, it passes this information, along with the email itself, to the Sending Entity Verifier 140 (SEV). Briefly, its job is to verify whether the email really is from the entity the SEI 140 says it's from. The verification can include some notion of scoring the message on a scale (e.g, is it “safe” or “suspicious” or “malicious”). It then passes this information (via updates to email headers or other means) to the Markup Engine 150 which may add a human-readable banner and/or machine-readable headers to the email. The Markup Engine 150 then passes the email to the Disposition Engine 160 which may deliver, quarantine, or folder the email (e.g., to a Junk Folder) accordingly associated with an email recipient (“client”) 180.

Each of the SEI 130, SEV 140, Markup Engine 150, and Disposition Engine 160 will now be described in more detail.

### ——Design of SEI 130——

The SEI 130 may use a variety of novel techniques to answer the question “What entity would a human say this email is from”. Broadly speaking, these techniques cover two distinct categories of forgeries, (I) forgery of email from a company/brand and (II) forgery of email from an individual person. In a preferred implementation, different techniques are used for the two categories, such as:
1) Machine learning and computer vision techniques to identify apparent company (brand) sender.
2) Approximate matching to identify apparent individual (person) sender, such as by maintenance of a social graph and sender profile information combined with anomaly detection.

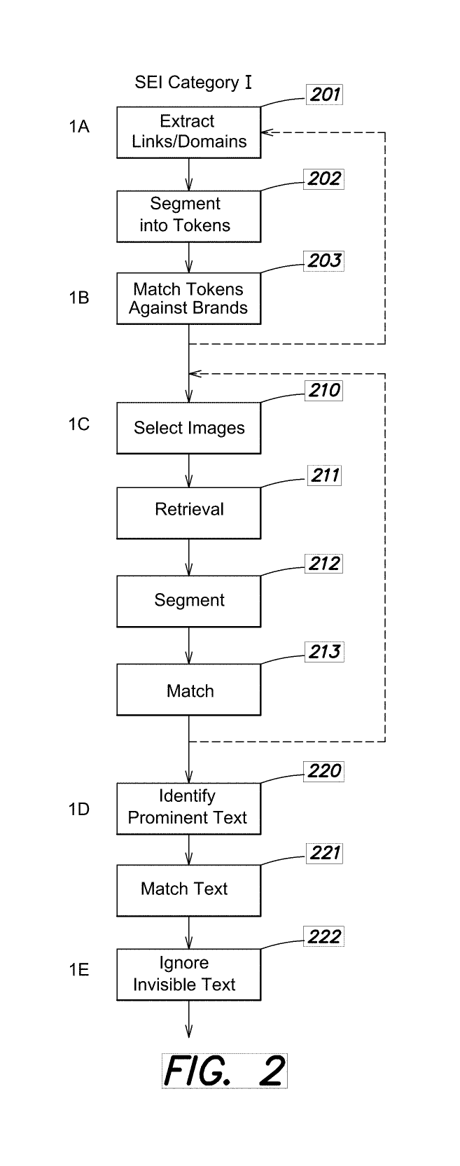

Specific techniques that may be used in Category (I) are shown in the flow diagram of FIG. 2. These may include:
1A) Extracting links 201 from the email body and scanning them for brand terminology. This involves first segmenting 202 each URL into tokens and then comparing 203 these tokens to terms indicative of brands.
   As an example, a URL such as
      https://login.amazon.storefront.com
   might be segmented or tokenized 202 into tokens (“login”, “amazon”, “storefront”), of which the amazon token would be considered indicative of the Amazon brand. Various tokenization strategies can be employed, but generally comprise a) a simplification step (remove/simplify punctuation, case and accent folding, Unicode normalization) followed by b) a dividing step (divide on punctuation or other separators, divide according to known words in a particular language—a task known as word segmentation), followed by c) a matching/lookup step (exact, substring, edit-distance, or Unicode skeleton matching of each token or subset of tokens against a database of known brand terms that is either manually curated or automatically generated via web scraping or similar techniques).
1B) After extracting 201 domain names from the email headers and body, and tokenizing 202 them as in (1A), the are then matched (1B) by comparing 203 them to domain names associated with specific brands. As in (1A), the matching process 203 may be defined in three steps: a) simplification, b) tokenization, c) matching/lookup.
1C) Retrieving images referenced in the email and determining whether they are indicative of a brand. This incorporates a) a selection step 210, b) a retrieval step 211, c) a segmentation step 212, and d) a matching step 213 applied to each image referenced in the email. The selection step 210 involves examining all of the images in a message (e.g., images displayed in an HTML-formatted message, inlined attachments, etc.), and deciding which image or images (if any) serve as a header or logo image with the intent of conveying the identity of the sender. Some emails may not have any brand-identifying images, while others may have several. Among several potential brand images, only one of them is likely to represent the brand of the sender, while others may simply be related to other content in the message.
   By way of example, consider an email newsletter for a technology web site. It may have its own brand logo at the top, followed by news headlines and brand imagery for other technology companies. The email may also contain other miscellaneous graphics and images for design purposes (line separators, clip art, etc). The selection step 210 requires discerning the brand logo at the top from all of the other images in the HTML. This step may use various heuristics based on the HTML structure, the images' relative sizes and locations on the page, the URLs and path names of the image files, and potentially the image content itself.
   For retrieval 211, a given image selected in the first step may be directly incorporated into the email as an attachment; it may be inlined as a data URI; or it may be hosted remotely on a server—the retrieval step acquires the raw image data given the appropriate access mechanism.
   The segmentation step 212 takes a given image and divides it into subimages. (Intuitively, this is required because indicative images like brand logos may not appear in isolation; instead, the subimages may be included in an image composed of multiple smaller images arranged onto, say, a white background.) The image segmentation step 212 may use various techniques: compression-based methods, histogram-based methods, multi-cropping, frequency analysis via Fourier transforms or Discrete Cosine Transforms, graph-partitioning methods, and ad hoc domain-specific methods. The output of the image segmentation step—a further set of (possibly smaller) images is then fed into the matching step 213.
   The goal of the matching step 213 is to accurately predict whether a given image is indicative of a particular brand. This step can be built using (exact image matching, approximate image matching, ssdeep matching, perceptual hashing, image fingerprinting, optical character recognition, convolutional neural networks). Each image may be compared against a database of manually curated images, automatically scraped images, or machine learning models derived by training against such databases.
1D) This part involves identifying text in the mail with particular prominence, and matching this text against terms indicative of a brand. This incorporates a) a prominent-text identification step 220, and b) a matching step 221 applied to the prominent text. Step 220 may use HTML rendering and/or parsing followed by examination of font characteristics such as size, family, and weight; text color, background color or alignment; proximity to special words or symbols such as a copyright symbol or unsubscribe link. In the matching step each identified text string may be compared against either a manually curated or automatically scraped database of brand terms, using tokenization, simplification, and matching/lookup techniques described in (1A) above.
1E) Techniques described in (1D) may also be used to filter out text intended by attackers to confuse the techniques above. Examples include identifying and ignoring text 222 that is invisible to humans because it is too small or lacks sufficient contrast.

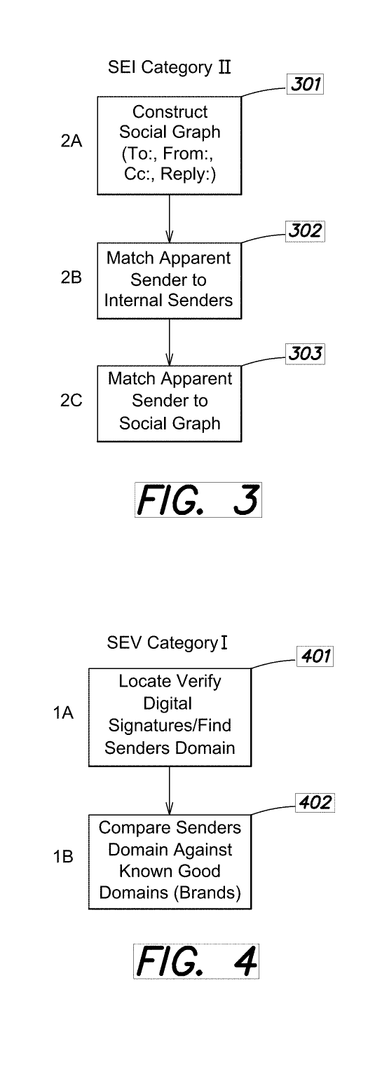

Specific techniques used by the SEI in category II are shown in FIG. 3. These may include:
2A) Constructing 301, in memory or a database, (of, for example, a graph representation) of the social graph implied by the To:, From:, Cc:, Sender:, and Reply-To: headers of all mail processed by the system over all time.
2B) Matching/lookup 302 of apparent sender to database of internal senders (e.g., employees or other individuals associated with the same organization as the recipient). This database may be manually curated or derived automatically by querying Active Directory, LDAP, or similar.
2C) Matching/lookup 303 of apparent sender to senders in the social graph described in (2A). In both (2B) and (2C), the comparison may be done by (exact, substring, edit-distance, Unicode skeleton, nickname, phonetic, soundex, metaphone, double-metaphone matching) of any subset of (email address, name, description).

### ——Design of SEV (#5)——

Given the output of the SEI 130, the SEV 140 then uses a variety of novel techniques to answer the question “Is this email in fact from the entity output by the SEI”? Broadly speaking, these techniques fall into two distinct categories (I) and (II):
(I) Cryptographic techniques
(II) Heuristic techniques

Specific techniques used in SEV Category (I) are shown in the flow diagram of FIG. 4. These may include:
1A) Location and verification 401 of digital signatures to establish sender's domain. A set of internet standards (DKIM, SPF, DMARC) provides guidelines for senders on how to digitally sign outgoing emails using a secret private key via standard cryptographic techniques. These standards also facilitate publication by senders, via DNS records, of lists of domain names that are allowed to send email on their behalf. If an email is digitally signed using DKIM, it can be used to definitively determine the sender's domain name.
1B) Comparison 402 of the sender's domain against a list of known-good sending domains for the related brand. This consists of a lookup in a database of domain names indexed by brand; this database may be manually curated or automatically scraped, and may be augmented and improved via additional processing of public WHOIS data.

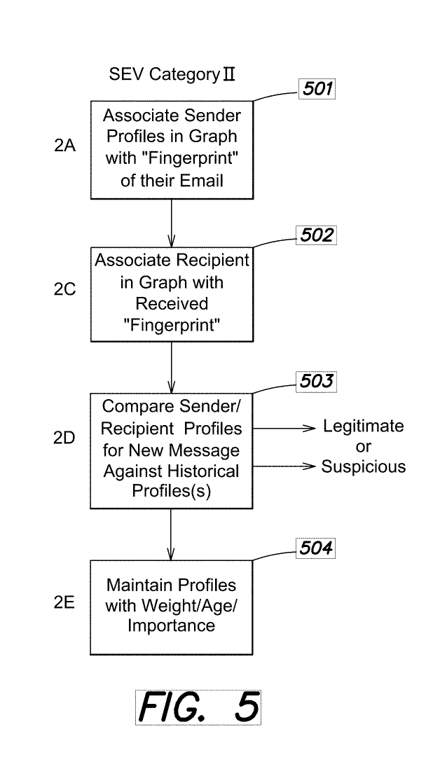

Specific techniques used in SEV category (II) are shown in the flow diagram of FIG. 5 and may include:
2A) Association 501 of a “sender profile” with each sender in the social graph (described in SEI 2A (step 301)), where the profile is derived from the set of emails sent by the related sender. Intuitively, the sender profile records “what typical emails from this sender look like” for that sender. This profile aggregates a set of fingerprints derived from emails sent by the sender, where each fingerprint captures a specific “look and feel” of email from that sender. The fingerprint may be derived from emails via features such as: the presence or absence of certain headers; the geolocations of IP addresses referenced in the email; the geographic path the email traversed from sender to recipient, as indicated by the geolocation of the Received: headers; character set and/or encodings used; originating mail client type; MIME structure; properties of the text or html content; stylometric properties such as average word length, sentence length, or reading grade level. The extracted features may be aggregated into the fingerprint via model building (statistical machine learning such as deep neural networks, Support Vector Machines, decision tree, or nearest-neighbor clustering). Feature hashing may be used to account for the large feature space and allow for new features to be added over time, as new email examples are encountered.
2C) Association 502 of a “recipient profile” with each recipient in the social graph, where the profile is derived from the set of emails received by the related sender.
2D) Comparison 503 of the sender and/or recipient profiles for a given email against historical sender and/or recipient profiles in the social graph output by SEI-2A (step 301). If the email profile matches a related stored profile within a given error rate, the email is assumed to be legitimate. Otherwise, it's assumed to be suspicious.
2E) Maintenance 504 of sender/recipient profiles over time as new emails arrive, with different levels of import potentially assigned to emails of a particular age. For example, features from emails from over a year ago may be given less weight in constructing the aggregate fingerprint than features from emails arriving today.

### ——Design of Markup Engine 150——

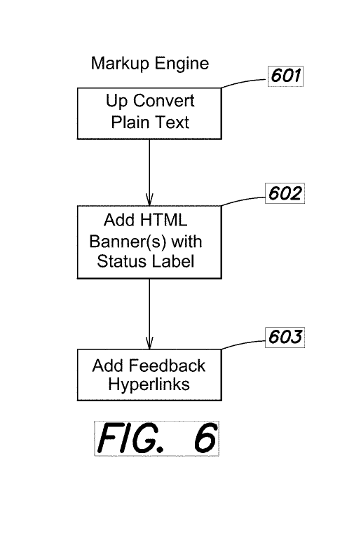

The markup engine 150 makes the determinations made by the SEI 130 followed by SEV 140 process visible to end user humans, to downstream mail processing software, or to both. It also may add links to the email to facilitate user feedback. Specific techniques used by the markup engine as shown in FIG. 6 may include:
1) Automatic up-conversion 601 of text/plain MIME parts to text/html so that HTML banners may be added to the email.
2) Addition of optionally color-coded HTML banners 602 with user-friendly feedback about the status of the message (e.g., “This message appears to be impersonating Amazon.com”)
3) Addition of hyperlinks 603 to the message to allow end users to provide feedback, report false positives or negatives, or to get more detailed information about the warnings or about the mail protection system itself.

### ——Social Graph——

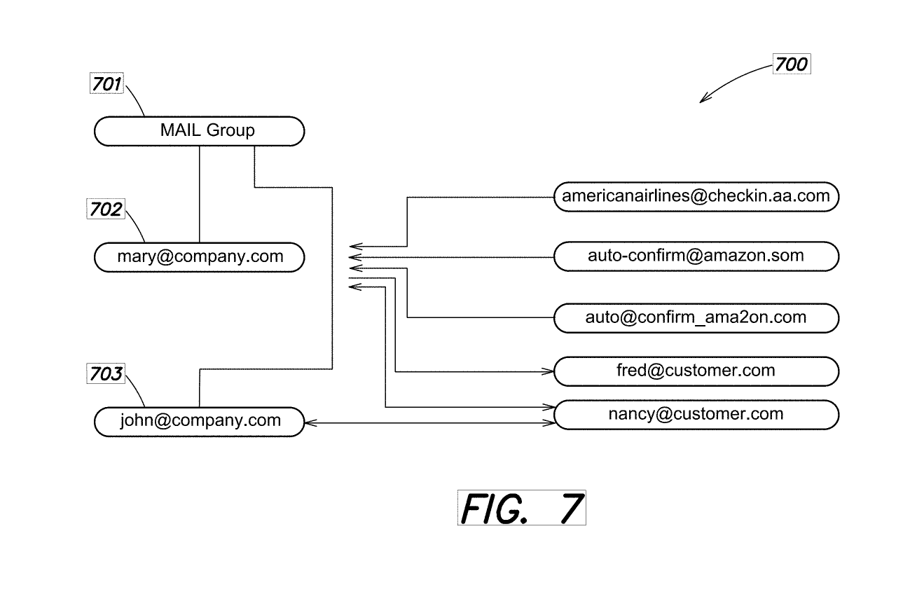

FIG. 7 is an example social graph that may be used. The social graph 700 may be maintained in a relational database or in other ways. The social graph 700 consists of nodes (e.g., node 701) for each email address the server detects. Branches between nodes may be indicative of various relationships, such as membership in a group 701, or sender-recipient groups. In the example shown, branches between node 701 and 702 and between node 701 and 704 indicate that mary@company.com and john@company.com are each a member of the same Mailgroup 701 for the organization called “company.com” and are thus internal to one another.

The graph 700 shows mary@company.com has received messages from three external senders, two of which are from an authentic sender (americanairlines@checkin.aa.com) and (auto-confirm@amazon.com) and one message an apparent brand impersonation (auto@confirm_ama2on.com). Mary has also sent a message to another external recipient, fred@customer.com, and has both sent and received emails with nancy@customer.com and fred@customer.com. john@customer.com has also exchanged messages with fred@customer.com.

As alluded to above, in some implementations, attributes (or “features”) may be associated with the nodes or relations in the social graph of FIG. 7. Some features of emails retained in the graph may include sender IP address, receiver IP address, domain names, sent time and date, received time and date, SPF or DKIM records, transit time, to:, from:, cc: and subject: fields, friendly names, attachment attributes, header details, gmail labels, x-mailer attributes, and/or any of the “fingerprint” attributes mention above. Note that these features may be weighted such that one or more are considered more important than others in determining whether a particular sender is to be trusted.

### ——Design of Markup Engine 150——

The markup engine 150 uses the results of the SEI 130 and SEV 140 to assign a classification to a message. The basic intuition is that if a message looks “funny”—that is, it is from a sender the recipient has never received mail from before, or looks to have a different sender profile than prior mails from the claimed sender—then the presence of “sensitive content” in the body might cause the mark up engine to consider a mail malicious rather than merely unusual.

Examples of “sensitive content” emails include:
requests to wire money
requests to pay an invoice
“your mailbox is over quota” messages
“please confirm your email account” messages
“you must change your password” messages
“you've won a prize!” messages
“you've earned a gift certificate” messages

These classifiers rely heavily on analysis of the text in the main body part of the email, but look at other features of a message as well. So at a high level, the idea is to is build specialized classifiers for one or more of these categories and a confidence value. For example, the markup engine 150 has a classifier that, given an email, can return a confidence value as to whether that email is a wire request.

In the context of the present system 100, these additional classifiers are then used by the markup engine 150 to augment the forgery detection process performed by the SEI 130 and SEV 140. So, as mentioned earlier, if SEI/SEV conclude that a mail looks like it might be forged—and there is a highly confidence that it fits into one of the “sensitive content” categories above (accordingly to the related classifiers), then the markup engine 150 is even more likely to consider the mail to be a problematic (malicious) forgery.

### ——Mail Forgery Examples——

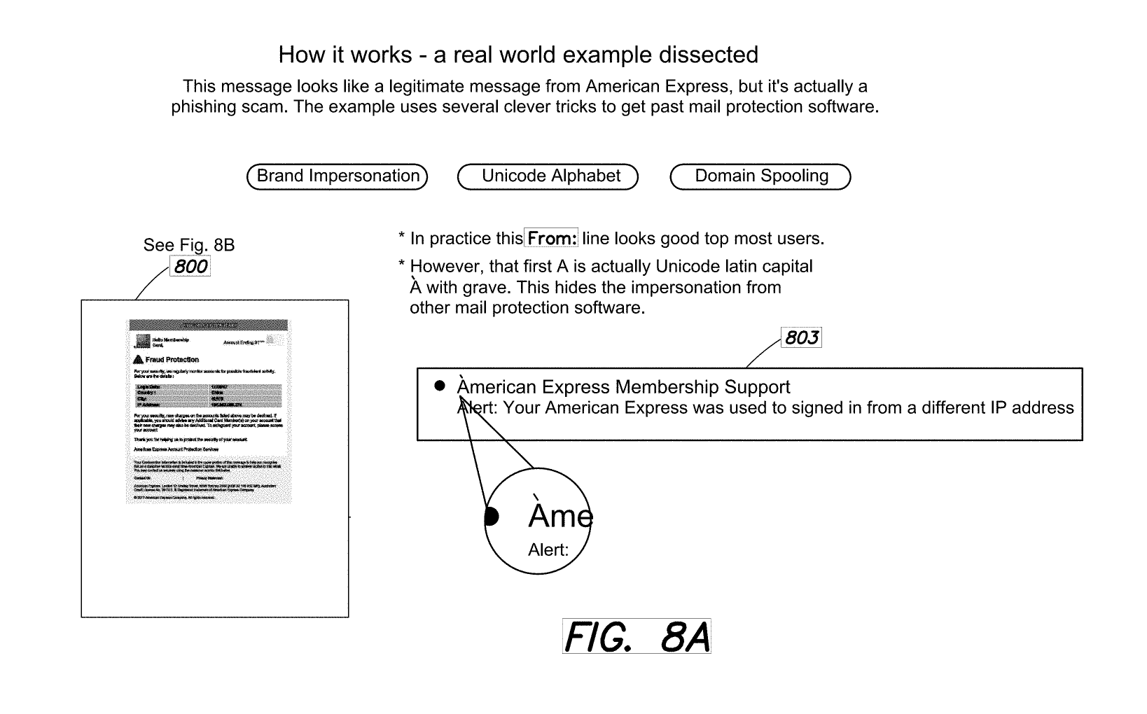

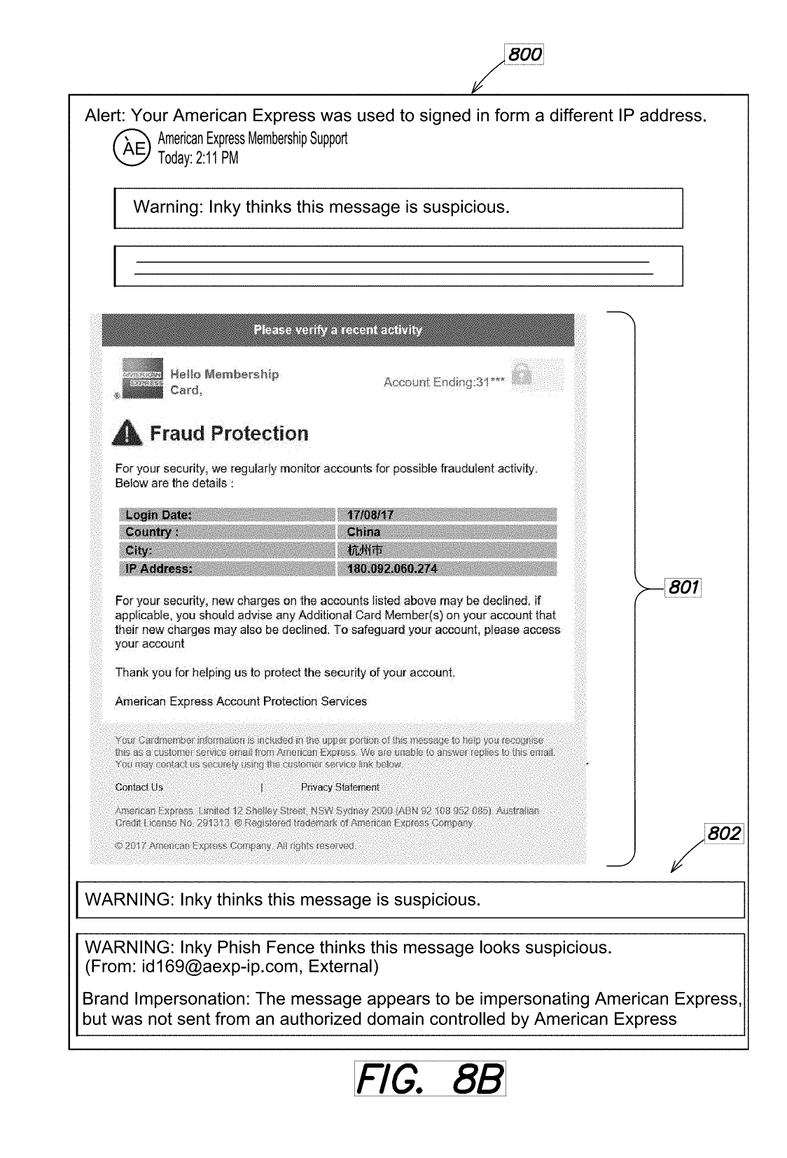

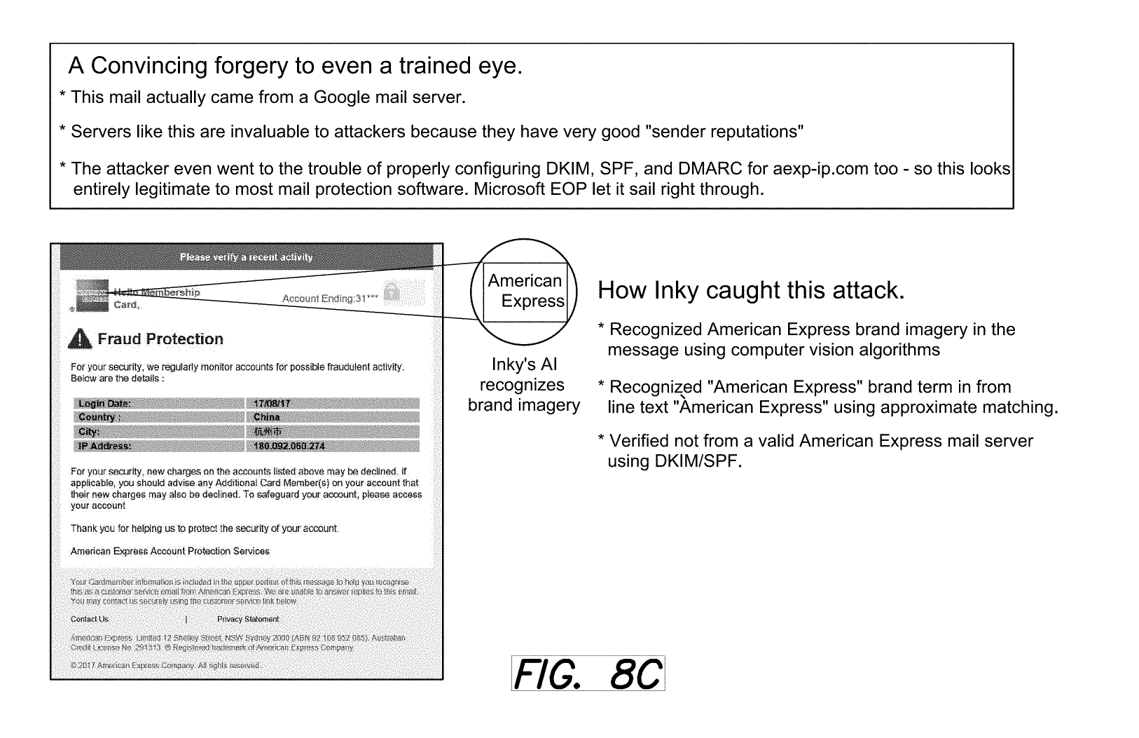

FIG. 8A is an example of a phishing attack from someone attempting to impersonate a famous brand. The message 800 appears to be a legitimate message from American Express, but is actually a clever phishing scam. The originator of the message used several tricks to avoid detection by email protection software—including brand impersonation, Unicode codepoints, and domain spoofing.

From the perspective of a human looking at this message, the From: line looks good to most people. However on careful inspection 803, that first “A” in “American Express” is actually a Unicode Latin capital A with accent grave. This use of Unicode characters might typically hide the impersonation from mail protection software.

Markup engine 150 (which the user sees as a service called “Inky Phish Fence”) in this example has added a banner 802 to the message indicating that it has concluded the message is suspicious.

The banner even tells the user that the message appears to be impersonating the brand American Express but was not actually sent from an authorized domain controlled by American Express.

As per FIG. 8B, the SEI 130 concluded that American Express was the apparent sender based upon the inclusion of American Express brand imagery in the message.

Interpretable text for a brand, “American Express”, was also noted in the message.

However SEV 140 determined that the email actually originated from a Google mail server, using DKIM/SPF, and the message was therefore flagged as suspicious.

Services such as Google mail are invaluable to mail forgers because they have very good sender reputations. For example, the attacker here using a Google mail server also went to the trouble of properly configuring a domain he controls (aexp-ip.com) with DomainKeys Identified Mail (DKIM), Sender Policy Framework (SPF) SPF, and/or Domain-based Message Authentication, Reporting & Conformance (DMARC). Thus, this mail will look legitimate to many other email systems, such as Microsoft Exchange Online Protection (EOP), that only rely on these domain validation, registration, and authentication services.

In this particular example, the SEV 140 was able to check a list of legitimate domain names for famous brands, and then determined from DKIM/SPF checks that the message originated from amex-ip.com, which is not a valid American Express mail server.

Also embedded in this message 800 was some user interpretable text. For example the term “American Express Protection Services” is included in the body text, and appears to be a legitimate message notifying the user that a fraud protection alert has been put on their American Express credit card account. A classifier in the markup engine 150 may also have caught this “sensitive content”, with the markup engine 150 then also taking this into account before flagging the message as suspicious.

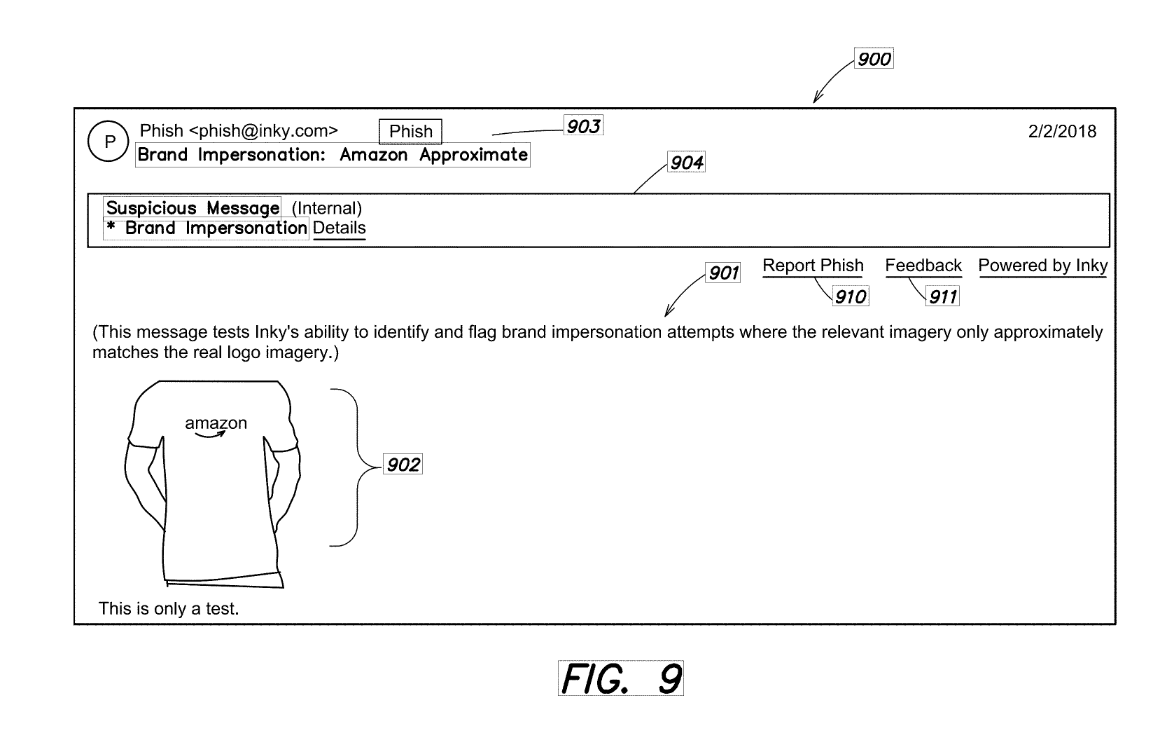

FIG. 9 is another example of a message 900 using brand imagery impersonation. Here the brand imagery does not appear as an exact icon or logo, but instead is an approximation of a famous brand image on a photograph of a t-shirt. Here the image analysis software only found an approximate match to the famous Amazon.com logo. However, the brand imagery match was sufficiently high to flag the message.

Again, a banner 904 is added to the message by markup engine 150 before it is sent to disposition engine 160.

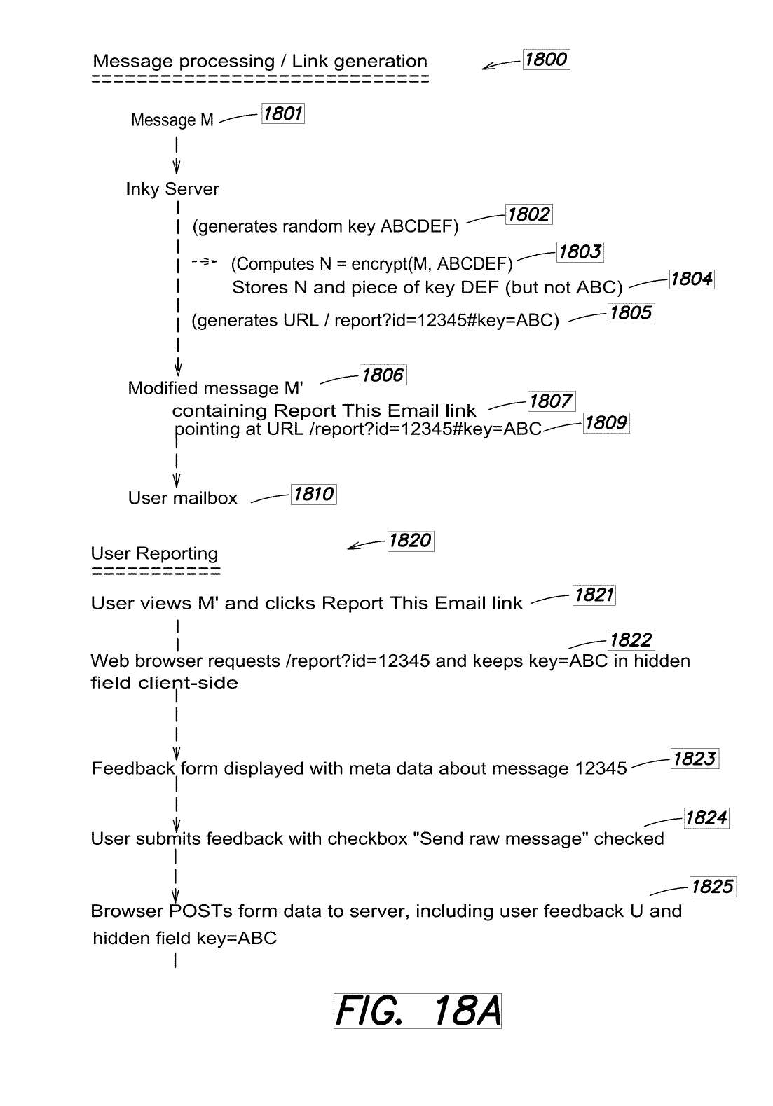

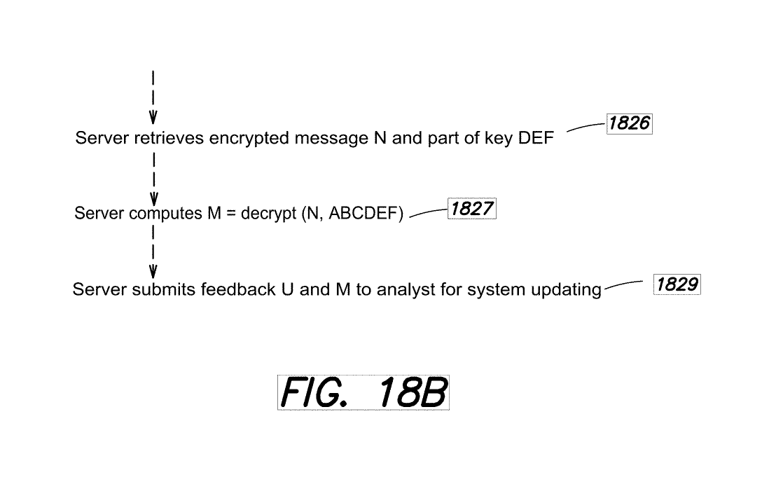

Also added to the message were several hyperlinks, such as link 910 inviting the user to report the message as a potential phish message. A process for generating that link in a particular way, for preserving the original message, and doing so while protecting the content of the message will be described in greater detail below in connection with FIGS. 18A and 18B. Banners 904 may be color-coded to indicate a level of severity. For example, a merely suspicious message might have a yellow banner, but a known phishing attack might have assigned to it a red banner.

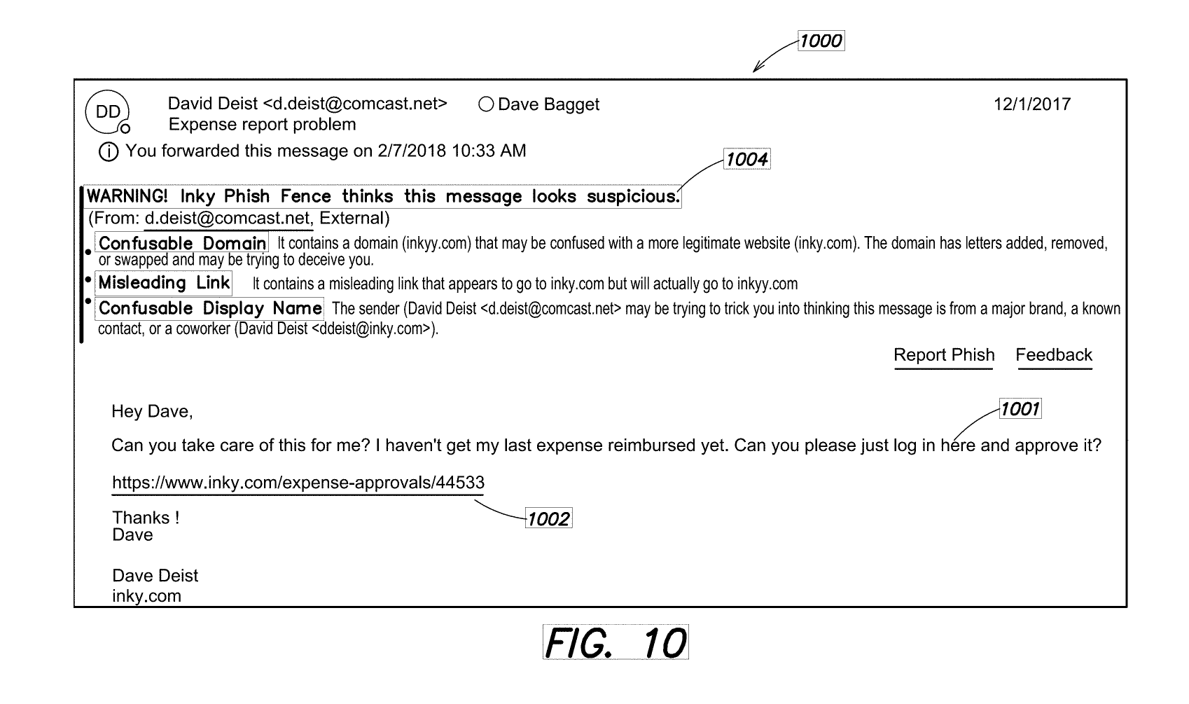

FIG. 10 is an example of an email 1000 that is impersonating an individual. The message was sent to a person, David Baggett, who works at a company called Inky. The message appears to be a request to approve reimbursement of business expenses from someone else who works at the same company.

As indicated in the banner 1004, the markup engine 150 concluded that the message is suspicious because it uses a confusable domain, included a misleading link in the body text, and has a confusable display name.

The message body contains an embedded hyperlink with displayable text that appears to point to one domain (inky.com) but which actually points to a different domain, inkyy.com The actual domain has letters added, removed, or substituted from a known contact.

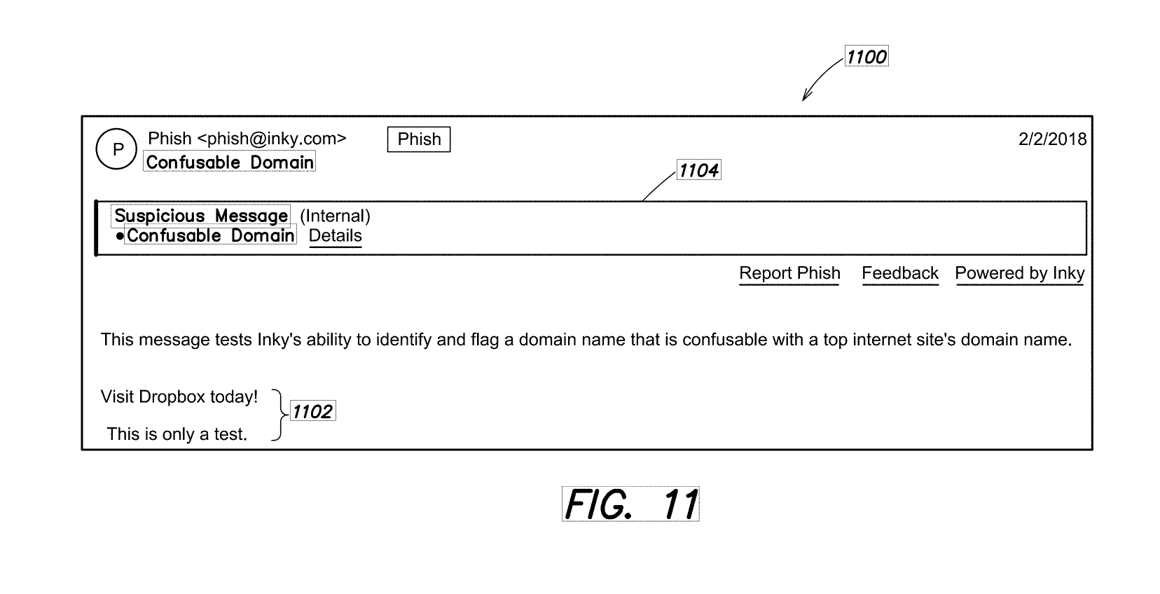

FIG. 11 is another example message 1100 that has content confusable with a famous brand (Dropbox). The embedded hyperlink is to a dropbox.com webpage but the message did not originate from there.

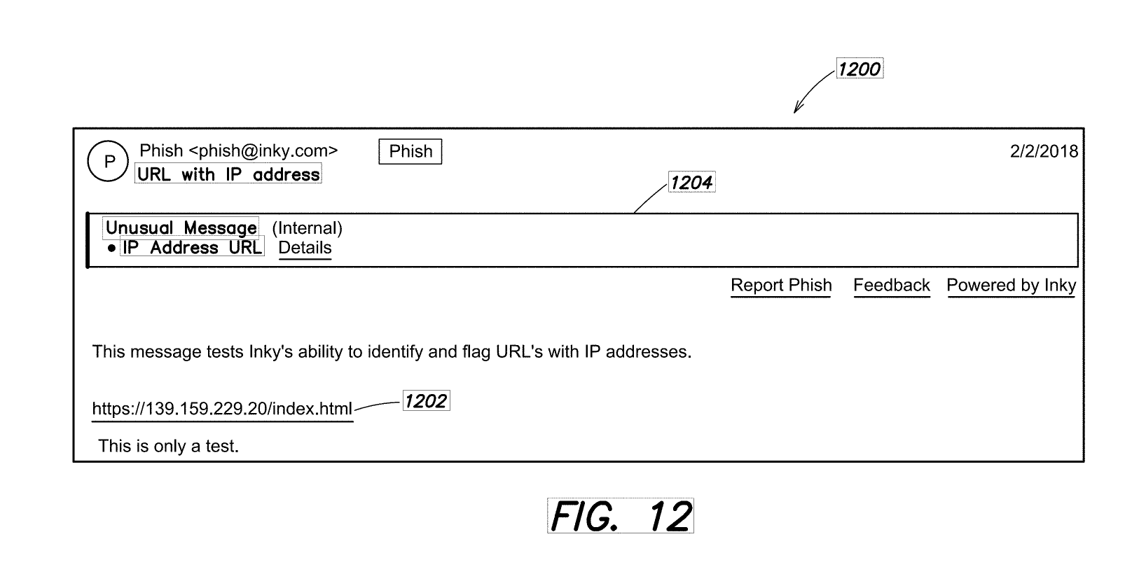

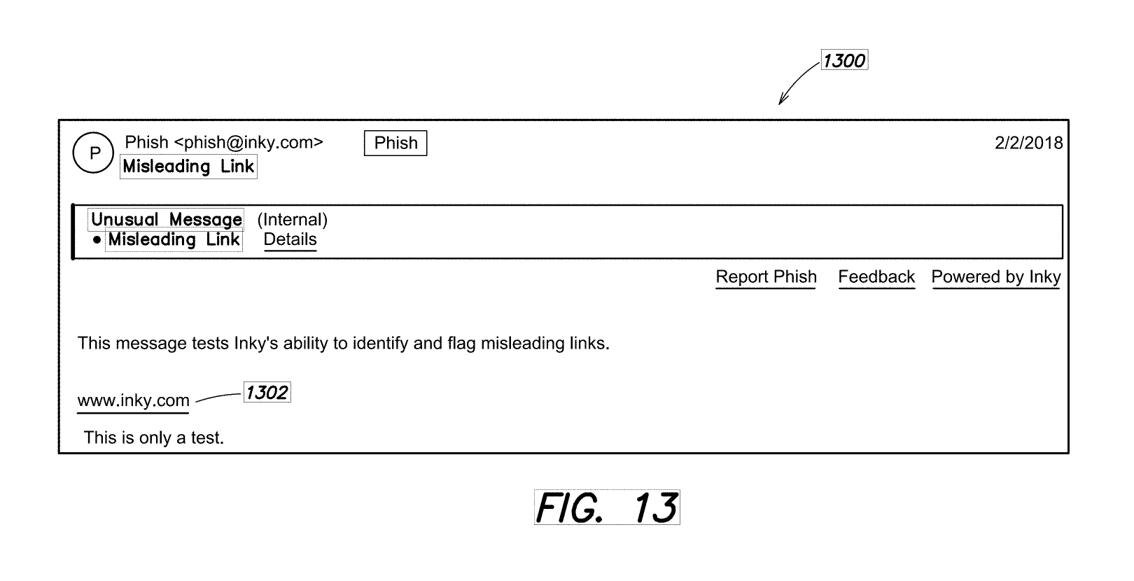

FIG. 12 is an example message 1200 that has a URL with an IP address. This may be flagged as an unusual message in banner 1204.

FIG. 13 is another message 1300 that has a misleading link.

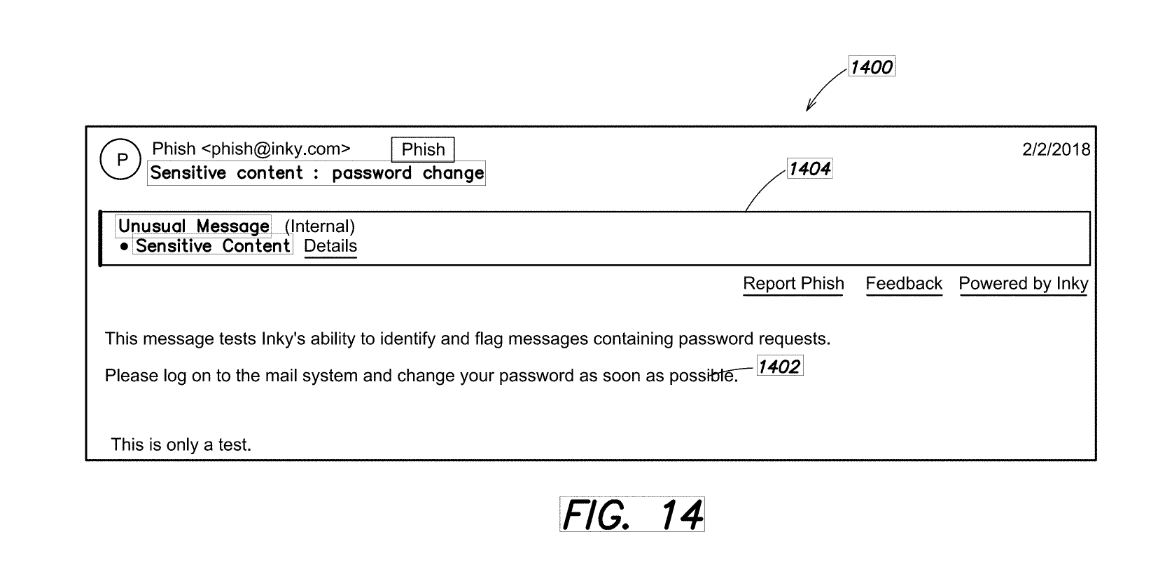

FIG. 14 is an example of a message that contains sensitive content in the form of a request to change a password.

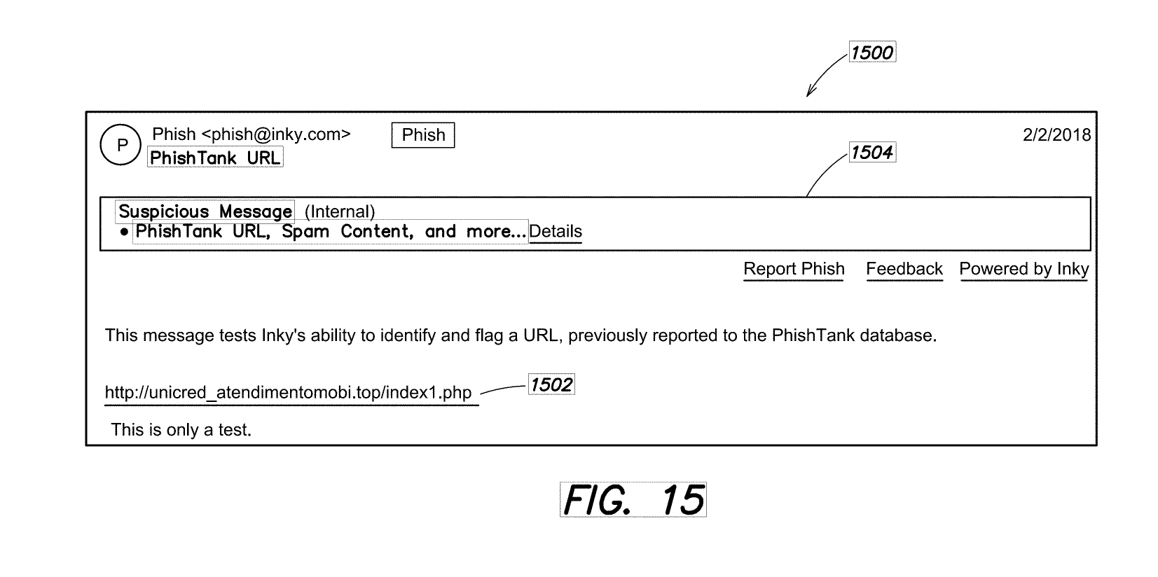

FIG. 15 is an example message 1500 that contains a URL that was previously reported by another user as being suspicious.

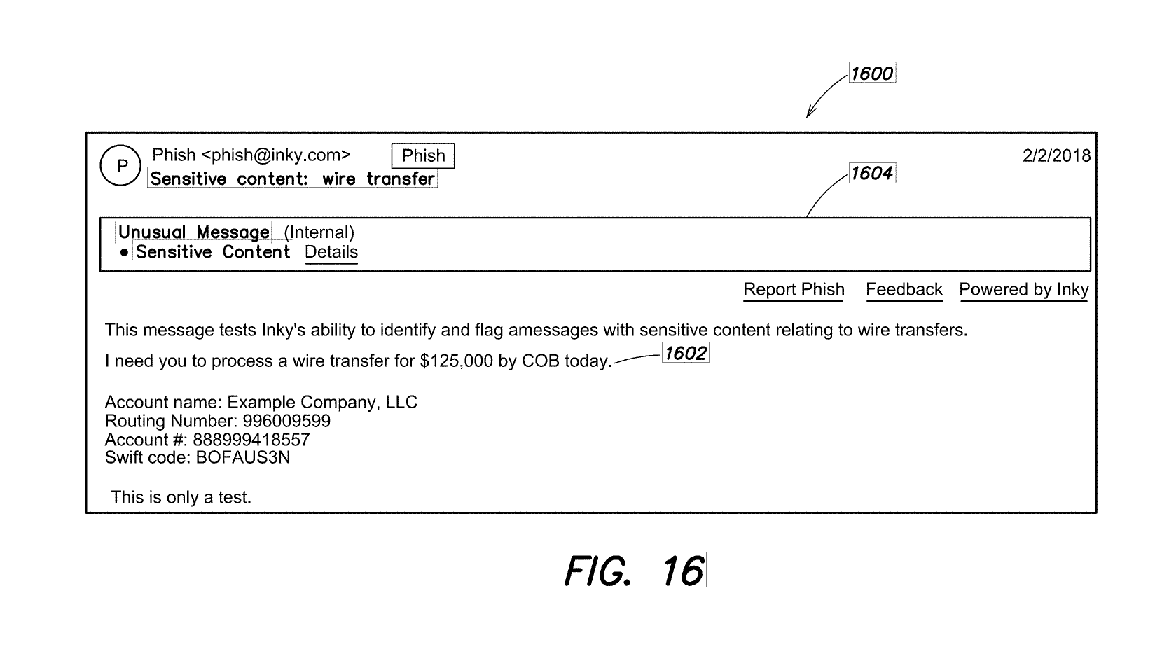

FIG. 16 is a message 1600 that includes sensitive content requesting a wire transfer 1602. This can be flagged with the appropriate banner 1604.

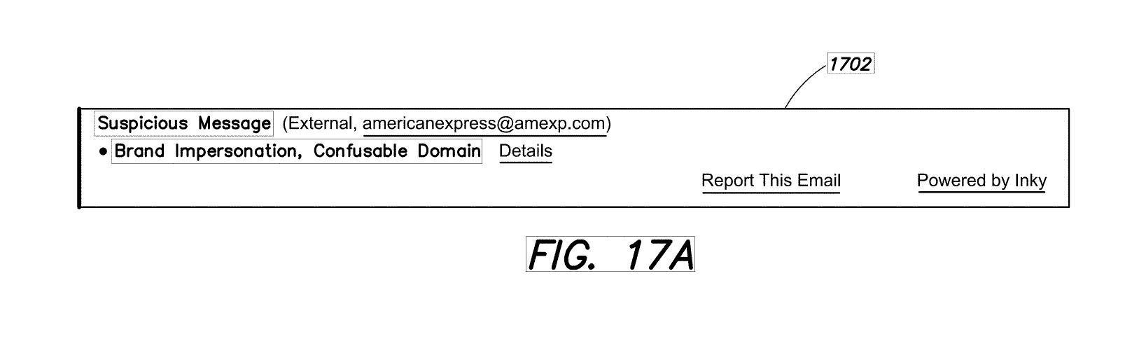

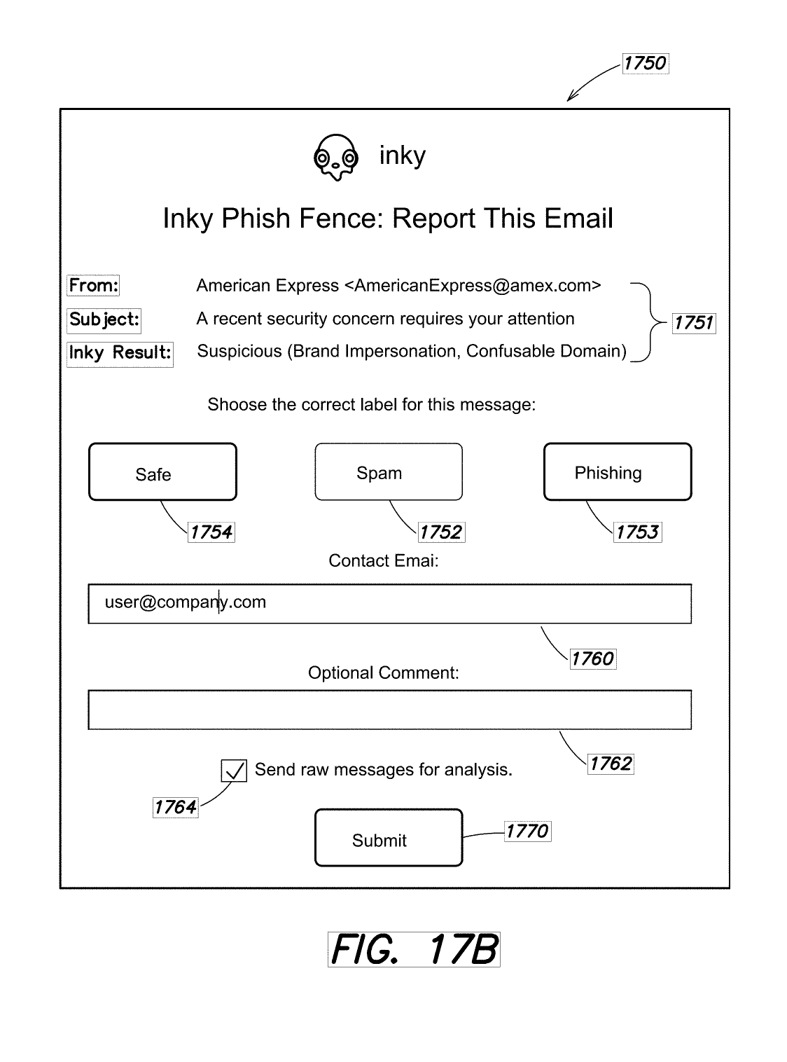

FIG. 17A is a more detailed view of a suspicious message banner 1702 that may be added to any of the above messages by the markup engine 150. In this particular example, the banner 1702 is the one added to the email of FIG. 8A, where a brand impersonation of American Express was attempted.

The banner 1702 includes a “Report this Email” hyperlink that enables the recipient to report the message. All email processed by the system can get modified with this hyperlink, enabling users to report false negatives or false positives, or to request whitelisting of certain types of mail.

An example reporting page reached after clicking on the link is shown in FIG. 17B displays a summary of who the message is from, the subject, and what the result was. The user interface displays the from: subject: and markup engine result 1751 (Brand Impersonation, Confusable Domain). The user may select a number of buttons (labeled safe 1751, spam 1752 or phishing 1753) to classify the message as they interpret it. The user's contact email 1760 with another field 1764 for optional comments may be included. Another checkbox 1764 asks permission from the user to store the raw message for further analysis.

FIGS. 18A and 18B are flow diagrams for a “Report This Email” hyperlink generation process 1800 and a user reporting process 1820.

As explained previously, the “Report This Email” hyperlink provides the ability for the message recipient to report an attempted phish. While the system 100 would benefit if the original raw message is retained identically as received for future analysis, the user may not want the content of all message to be stored in plain text. In other words, users are more likely to report suspicious messages if they can be confident the messages will remain confidential. So the processes used herein store messages in encrypted form, with the key to decrypt the message being stored as part of the hyperlink itself.

The processes shown in FIGS. 18A and 18B provide the most effective reporting by storing an unprocessed copy of incoming mail in some manner, but also storing the mail encrypted in a way that even the provider of the email protection service cannot decrypt it until a user explicitly reports the email. Storing the mail in this way enables the reporting process to be as simple as clicking a link, and the end user doesn't need to know anything about finding the raw message source or forwarding mail as attachments. It is important to be able analyze the original mail when it reached the host(s) 120 instead of the version in a user's client inbox 180 (which may have been subsequently modified by the email protection service and potentially other systems).

One process for the way “Report This Email” supports storing encrypted copies of raw mail is as follows. When the markup engine 150 server 1802 processes an incoming message M 1801, a random encryption key is generated 1802 and used to encrypt 1803 the raw email data (e.g., RFC 2822 text). The encryption key is then split in two pieces, and one piece of the key is stored 1804 server-side along with the encrypted data. The other piece of the encryption key is encoded using hexadecimal and included 1805 in modified email M′ 1806 including the hash portion of the URL for the Report This Email link 1807. Unlike the query string portion of a URL, the hash is not sent to servers by a browser when loading the page. For example, the URL 1809 may look like https://feedback.inky.com/report?id=12345#key≤ABC. In this example, the link 1809 refers to the message with unique id 12345, whose data is encrypted on the server using encryption key ABC (along with another piece of the key DEF held by Inky).

User reporting 1820 is initiated when a user views the modified message M′ and clicks 1821 this link in their email client 180 (FIG. 1). Their default web browser will load 1822 the URL https://feedback.inky.com/report and transmit the query string “id=12345,” keeping the key=ABS in a hidden field on the client side. This then tells the web server what message to retrieve unencrypted details/meta-data about. The feedback form page is then displayed 1823 with a checkbox option 1764 to send the raw message data to the protection service provider Inky for analysis. If that checkbox is checked 1824 when the user clicks the Submit button, only then is the key=ABC value transmitted 12825. Then, and only after receiving 1826 this key, can the server can decrypt 1827 the previously stored message data in order to associate the user feedback 1829 with the original raw message to re-train machine learning models, update blacklists, etc.

### ——Example of Detecting Spear Phishing/Impersonation——

The attached Appendix includes examples of the type of spear phishing and/or impersonation that the Sending Entity Verifier (SEV) 140 can detect for individual senders (e.g., SEV Category II described above). All three examples appear to be from an individual named John Doe and relate to someone's 40th birthday. But header analysis and historic profiling reveal that the first two, legitimate messages are actually quite different from the last message, which is a spear phishing message.

The first two messages in the Appendix are legitimate messages. They came from different servers, but were Gmail servers located in the United States (e.g., 209.85.220.41, 209.85.220.48). The third message, a spoofed message, comes from Brazil (150.165.253.150). It also made several other hops along the way.

All three messages are DKIM-signed and receive a passing result. However, the spoofed message is signed by “cchla.ufpb.br” and thus was NOT signed by “gmail.com” like the legitimate messages.

Other differences include headers added and removed. For example, the two legitimate Gmail messages have an X-Gm-Message-State, and an X-Google-Smtp-Source, whereas the spoofed message has X-Mailer, X-Virus-Scanned, and DKIM-Filter.

There are also differences in the MIME structure. For example, the two legitimate messages are multipart/alternative while the spoofed message is just a single text/plain message.

### ——Data Processing Environment Implementation Options——

The foregoing example embodiments provide illustration and description of systems and methods for implementing email protection, but are not intended to be exhaustive or to be limited to the precise form disclosed.

For example, it should be understood that the embodiments described above may be implemented in many different ways. In some instances, the various “data processing systems” described herein may each be implemented by a separate or shared physical or virtual general purpose computer having a central processor, memory, disk or other mass storage that store software instructions. These systems may include communication interface(s), input/output (I/O) device(s), and other peripherals. The general purpose computer is transformed into the processors with improved functionality, and executes the processes described above to provide improved operations. The processors may operate, for example, by loading software instructions, and then executing the instructions to carry out the functions described.

Embodiments may therefore typically be implemented in hardware, firmware, software, or any combination thereof. In some implementations, the computers that execute the processes described above may be deployed in a cloud computing arrangement that makes available one or more physical and/or virtual data processing machines via a convenient, on-demand network access model to a shared pool of configurable computing resources (e.g., networks, servers, storage, applications, and services) that can be rapidly provisioned and released with minimal management effort or service provider interaction. Such cloud computing deployments are relevant and typically preferred as they allow multiple users to access computing. By aggregating demand from multiple users in central locations, cloud computing environments can be built in data centers that use the best and newest technology, located in the sustainable and/or centralized locations and designed to achieve the greatest per-unit efficiency possible. Furthermore, firmware, software, routines, or instructions may be described herein as performing certain actions and/or functions. However, it should be appreciated that such descriptions contained herein are merely for convenience and that such actions in fact result from computing devices, processors, controllers, or other devices executing the firmware, software, routines, instructions, etc.

It also should be understood that the block and network diagrams may include more or fewer elements, be arranged differently, or be represented differently. It further should be understood that certain implementations may dictate the block and network diagrams and the number of block and network diagrams illustrating the execution of the embodiments be implemented in a particular way.

Other modifications and variations are possible in light of the above teachings. For example, while a series of steps has been described above with respect to the flow diagrams, the order of the steps may be modified in other implementations. In addition, the steps, operations, and steps may be performed by additional or other modules or entities, which may be combined or separated to form other modules or entities. For example, while a series of steps has been described with regard to certain figures, the order of the steps may be modified in other implementations consistent with the principles of the invention. Further, non-dependent steps may be performed in parallel. Further, disclosed implementations may not be limited to any specific combination of hardware.

Certain portions may be implemented as “logic” that performs one or more functions. This logic may include hardware, such as hardwired logic, an application-specific integrated circuit, a field programmable gate array, a microprocessor, software, wetware, or a combination of hardware and software. Some or all of the logic may be stored in one or more tangible non-transitory computer-readable storage media and may include computer-executable instructions that may be executed by a computer or data processing system. The computer-executable instructions may include instructions that implement one or more embodiments described herein. The tangible non-transitory computer-readable storage media may be volatile or non-volatile and may include, for example, flash memories, dynamic memories, removable disks, and non-removable disks.

No element, act, or instruction used herein should be construed as critical or essential to the disclosure unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

Also, the term “user”, as used herein, is intended to be broadly interpreted to include, for example, a computer or data processing system or a human user of a computer or data processing system, unless otherwise stated.

The foregoing description has been directed to specific embodiments of the present disclosure. It will thus be apparent, however, that other variations and modifications may be made to the described embodiments, with the attainment of some or all of their advantages. Therefore, it is the object of the appended claims to cover all such variations and modifications as come within the true spirit and scope of the disclosure and their equivalents.

```
APPENDIX
Legitimate Message 1:
Return-Path: <john@gmail.com>
Received: from mail-sor-f41.google.com (mail-sor-f41.google.com.
[209.85.220.41])
    by mx.google.com with SMTPS id
63sor1271989qth.102.2018.04.11.09.44.25
    (Google Transport Security);
    Wed, 11 Apr 2018 09:44:25 -0700 (PDT)
Received-SPF: pass (google.com: domain of john@gmail.com
designates
209.85.220.41 as permitted sender) client-ip=209.85.220.41;
Authentication-Results: mx.google.com;
    dkim=pass header.i=@gmail.com header.s=20161025
    header.b=SKd8nAlO;
    spf=pass (google.com: domain of john@gmail.com designates
209.85.220.41 as permitted sender) smtp.mailfrom=john@gmail.com;
    dmarc=pass (p=NONE sp=QUARANTINE dis=NONE)
    header.from=gmail.com
DKIM-Signature: v=1; a=rsa-sha256; c=relaxed/relaxed;
d=gmail.com;
s=20161025;
    h=mime-version:references:in-reply-to:from:date:message-
id:subject:to:cc;
    bh=. . .; b=. . .
X-Google-DKIM-Signature: v=1; a=rsa-sha256; c=relaxed/relaxed;
d=1e100.net;
s=20161025;
    h=x-gm-message-state:mime-version:references:in-reply-
to:from:date:message-id:subject:to:cc;
    bh=. . .; b=. . .
X-Gm-Message-State: ALQs6tBv. . .
X-Google-Smtp-Source: AIpwx490T. . .
X-Received: by 10.200.53.164 with SMTP id
k33mr8405274qtb.37.1523465064900;
Wed, 11 Apr 2018 09:44:24 -0700 (PDT)
MIME-Version: 1.0
References: <CAL+9f6CR7xwS4-
Wo2wYyqk+xniQgkoPwoRHyTLW+=82gx9sRdQ@mail.gmail.com>
In-Reply-To: <CAL+9f6CR7xwS4-
Wo2wYyqk+xniQgkoPwoRHyTLW+=82gx9sRdQ@mail.gmail.com>
From: John Doe <john@gmail.com>
Date: Wed, 11 Apr 2018 16:44:14 +0000
Message-ID: <CAGskw+-JvZin0mh-
P+sm7WCFeLyxBpfU8KK3wgyT7MSgONsiLw@mail.gmail.com>
Subject: Re: 40th birthday
To: Jane Doe <jane@gmail.com>
Content-Type: multipart/alternative;
boundary=“001a113f275a056ed10569955ad2”
. . . .
Legitimate Message 2:
Return-Path: <john@gmail.com>
Received: from mail-sor-f48.google.com (mail-sor-f48.google.com.
[209.85.220.48])
    by mx.google.com with SMTPS id
63sor1271989qth.102.2018.04.10.12.24.25
    (Google Transport Security);
Tue, 10 Apr 2018 12:24:25 -0700 (PDT)
Received-SPF: pass (google.com: domain of john@gmail.com
designates
209.85.220.48 as permitted sender) client-ip=209.85.220.48;
Authentication-Results: mx.google.com;
    dkim=pass header.i=@gmail.com header.s=20161025
    header.b=SKd8nAlO;
    spf=pass (google.com: domain of john@gmail.com designates
209.85.220.48 as permitted sender) smtp.mailfrom=john@gmail.com;
  dmarc=pass (p=NONE sp=QUARANTINE dis=NONE)
  header.from=gmail.com
DKIM-Signature: v=1; a=rsa-sha256; c=relaxed/relaxed; d=gmail.com;
s=20161025;
    h=mime-version:references:in-reply-to:from:date:message-
id:subject:to:cc;
    bh=. . .; b=. . .
X-Google-DKIM-Signature: v=1; a=rsa-sha256; c=relaxed/ relaxed;
d=1e100.net;
s=20161025;
    h=x-gm-message-state:mime-version:references:in-reply-
to: from:date:message-id:subject:to:cc;
    bh=. . .; b=. . .
X-Gm-Message-State: ALQs6tBv. . .
X-Google-Smtp-Source: AIpwx490T. . .
X-Received: by 10.200.53.163 with SMTP id
k33mr8405274qtb.37.1523465064800;
Tue, 10 Apr 2018 12:24:24 -0700 (PDT)
MIME-Version: 1.0
From: John Doe <john@gmail.com>
Date: Tue, 10 Apr 2018 19:24:14 +0000
Message-ID: <CAGskw+-JvZin2mh-
M+sm7WCFeLyxBpfU8KK3wgyT7MSgONseLw@mail.gmail.com>
Subject: 40th birthday
To: Jane Doe <jane@gmail.com>
Content-Type: multipart/alternative;
boundary=“001a113f275a056e546345645ae4”
. . . .
Spoofed Message 1:
Return-Path: <fabiolabrazaquino@cchla.ufpb.br>
Received: from mx1.ufpb.br (mx1.ufpb.br. +150.165.253.1501)
    by mx.google.com with ESMTPS id
m38s12763821qta.396.2018.04.03.20.48.08
    (version=TLS1_2 cipher=ECDHE-RSA-AES128-GCM-SHA256
    bits=128/128);
Tue, 03 Apr 2018 20:48:09 -0700 (PDT)
Received-SPF: pass (google.com: domain of
fabiolabrazaquino@cchla.ufpb.br
designates 150.165.253.150 as permitted sender)
client-ip=150.165.253.150;
Authentication-Results: mx.google.com;
    dkim=pass header.i=@cchla.ufpb.br header.s=mailcchla
header.b=YhPUXuIL;
    spf=pass (google.com: domain of
    fabiolabrazaquino@cchla.ufpb.br
designates 150.165.253.150 as permitted sender)
smtp.mailfrom=fabiolabrazaquino@cchla.ufpb.br
Received: from email.ufpb.br (email.ufpb.br [150.165.253.99])
by mx1.ufpb.br
(Postfix) with ESMTP id 04425B78; Wed,
  4 Apr 2018 00:47:51 -0300 (−03)
Received: from localhost (localhost [127.0.0.1]) by email.ufpb.br
(Postfix)
with ESMTP id 4C0D340631; Wed,
  4 Apr 2018 00:47:51 -0300 (BRT)
Received: from email.ufpb.br ([127.0.0.1]) by localhost (email.ufpb.br
[127.0.0.1]) (amavisd-new, port 10032) with ESMTP id
vmMobwDzlPyx; Wed,
  4 Apr 2018 00:47:49 -0300 (BRT)
Received: from localhost (localhost [127.0.0.1]) by email.ufpb.br
(Postfix)
with ESMTP id 1508A40674; Wed,
  4 Apr 2018 00:47:49 -0300 (BRT)
DKIM-Filter: OpenDKIM Filter v2.10.3 email.ufpb.br 1508A40674
DKIM-Signature: v=1; a=rsa-sha256; c=relaxed/relaxed;
d=cchla.ufpb.br;
s=mailcchla; t=1522813669;
  bh=. . .; h=MIME-Version:To:From:Date:Message-Id; b=. . .
X-Virus-Scanned: amavisd-new at email.ufpb.br
Received: from email.ufpb.br ([127.0.0.1]) by localhost (email.ufpb.br
[127.0.0.1]) (amavisd-new, port 10026) with ESMTP
id 5YUQHrhXVD1M; Wed,
  4 Apr 2018 00:47:48 -0300 (BRT)
Received: from [172.20.10.6] (unknown [197.210.25.123])
by email.ufpb.br
(Postfix) with ESMTPSA id 496E040655; Wed,
  4 Apr 2018 00:47:13 -0300 (BRT)
MIME-Version: 1.0
X-Mailer: Thunderbird
Content-Transfer-Encoding: quoted-printable
Content-Description: Mail message body
Subject: Re: 40th birthday
To: Jane Doe <jane@gmail.com>
From: John Doe <john@gmail.com>
Date: Wed, 04 Apr 2018 11:46:48 +0800
Reply-To: mikh.fridman@gmail.com
Message-Id: <20180404034714.496F040655@email.ufpb.br>
Content-Type: text/plain; charset=“iso-8859-1”
```

1. An automated method for determining if an email is a forgery comprising:
A. programmatically identifying who an apparent sender of the email is visually perceived to be by a human, by at least one of:
determining if the apparent sender is associated with a brand by the steps of:
when a hyperlink or domain name is found in the email;
tokenizing the hyperlink and/or domain name to provide a token;
matching the token against a list of brand names;
when an image is found in the email;
optionally segmenting the image to provide an image segment;
matching the image or an image segment against a list of brand name images;
when there is prominent text found in the email;
matching the prominent text against a list of brand names;
determining if the apparent sender is an individual by:
maintaining a social graph using a to: and from: and/or cc: fields in received emails; and
matching the to: field in the email against the graph of received emails
B. determining an actual sender of the email by the steps of:
when the apparent sender is a brand;
comparing one or more attributes of a digital signature of the email using a sender domain authentication protocol;
when the apparent sender is a person;
using one or more heuristics including one or more of
trust on first use;
matching the apparent sender against the social graph; and
C. determining the email is a forgery if the apparent sender does not match the actual sender.

2. The method of claim 1 additionally comprising:
clustering sender domains associated with a given brand in the list of brand names.

3. The method of claim 1 wherein the step of determining the email is a forgery further depends on a weighted score assigned to the result of one or more of the determining steps.

4. The method of claim 1 further considering any colors, fonts or other visual attributes when matching the prominent text.

5. The method of claim 1 additionally comprising:
ignoring any parts of the email that include text marked invisible, too small to be read, or with a font color that has insufficient contrast against a background color.

6. The method of claim 1 additionally
when the email includes a copyright or trademark symbol,
matching an adjacent name against the list of brand names

7. The method of claim 1 where the social graph further maintains a data structure for each sender that includes one or more attributes indicative of emails typically from the sender.

8. The method of claim 1 wherein the matching step may include matching by exact, substring, edit-distance, Unicode skeleton, nickname, phonetic, soundex, metaphone, double-metaphone matching) of any subset of an email address, name, or description.

9. The method of claim 1 wherein the authentication protocol is DKIM or SPF.

10. The method of claim 1 wherein the graph includes time stamps in each profile, such that newer messages are weighted more than older messages.

11. The method of claim 1 additionally comprising:
enabling a user to indicate feedback as to whether they think the email was a forgery, while maintaining an encrypted raw copy of the email.
